(19) United States
(12) Patent Application Publication
(10) Pub. No.: US 2022/0163362 A1
(43) Pub. Date: May 26, 2022

(54) CORIOLIS SENSOR AND CORIOLIS MEASURING DEVICE HAVING A CORIOLIS SENSOR

(71) Applicant: Endress+Hauser Flowtec AG, Reinach (CH)

(72) Inventors: Benjamin Schwenter, Breitenbac (CH); Marc Werner, Grenzach-Wyhlen (DE); Claude Hollinger, Aesch (CH); Gebhard Gschwend, Allschwil (CH)

(21) Appl. No.: 17/436,876

(22) PCT Filed: Feb. 14, 2020
(86) PCT No.: PCT/EP2020/053827

§ 371 Date: Sep. 7, 2021

(30) Foreign Application Priority Data
Mar. 7, 2019 (DE) 10 2019 105 736.1

(51) Int. Cl. G01F 1/84

(52) U.S. Cl. CPC G01F 1/8422; G01F 1/8404; G01F 1/8431; G01F 1/8427

(57) ABSTRACT

A Coriolis sensor includes: a measurement tube having an inlet and an outlet; an exciter; and two sensor elements, wherein the exciter and/or the sensor element respectively have a coil arrangement and a magnet arrangement, wherein the magnet arrangement has a retainer for magnets, at least one first magnet group and at least one second magnet group, wherein the retainer is U-shaped with a first arm, a second arm and a base connecting the arms, wherein the retainer engages around the coil arrangement, wherein the first magnet group is retained on the first side of the coil arrangement by the retainer, and wherein the second magnet group is retained on the second side of the coil arrangement by the retainer, wherein the retainer has a cavity in a region of each of the arms for receiving a magnet group, wherein the retainer is manufactured using a 3D printing process.

The invention relates to a Coriolis sensor having an improved sensor system or improved exciter unit, and to a Coriolis measuring device having such a Coriolis sensor.

Coriolis measuring devices for measuring a mass flow rate or a density of a medium flowing through a measurement tube of the measuring device are prior art. As shown by way of example in DE102015120087A1, a sensor element for detecting measurement tube vibrations, or an exciter for generating measurement tube vibrations, can comprise a planar coil and a U-shaped magnetic field-generating element which engages around the planar coil.

The disadvantage of such a magnetic field-generating element is the presence of a magnetic field, which has a fuzzy transition to a spatial region without a magnetic field. This results in a lower sensitivity of sensor elements.

The object of the invention is therefore to propose a Coriolis sensor and a Coriolis measuring device in which a higher sensitivity of the sensor elements is given.

The object is achieved by a Coriolis sensor according to independent claim 1, and by a Coriolis measuring device according to independent claim 13.

A Coriolis sensor according to the invention, of a Coriolis measuring device for detecting a mass flow rate or a density of a medium flowing through at least one measurement tube of the Coriolis measuring device, comprises: the at least one measurement tube having an inlet and an outlet, which tube is designed to convey the medium between the inlet and outlet; at least one exciter which is designed to excite the at least one measurement tube to vibrate; at least two sensor elements which are each configured to detect vibrations of at least one measurement tube, wherein at least one exciter and/or at least one sensor element each have a coil arrangement with respectively at least one coil, and each have a magnet arrangement, wherein the magnet arrangement and the coil arrangement are movable relative to one another, wherein the sensor has a supporting element which is configured to retain the at least one measurement tube, wherein the magnet arrangement has a retainer for magnets, and at least one first magnet group having at least one magnet, and at least one second magnet group having at least one magnet, wherein the retainer has a U-shape with a first arm, and a second arm, and a base connecting the arms, wherein the retainer engages around the coil arrangement so that the first arm is arranged on a first side of the coil arrangement with respect to a coil cross section, and wherein the second arm is arranged on a second side of the coil arrangement, wherein the first magnet group is retained on the first side of the coil arrangement by the retainer, and wherein the second magnet group is retained on the second side of the coil arrangement by the retainer, wherein the retainer has a cavity in the region of each of the arms, wherein the cavities are configured to receive the magnet groups, wherein the cavities are each formed by a cavity wall, wherein each cavity wall has at least one first opening for receiving a magnet group, wherein the retainer is produced especially by means of a 3D printing process.

By receiving the magnet groups in corresponding cavities while dispensing with the generation of magnetic fields by the retainer, a spatially well-localized magnetic field can be produced with respect to the retainer, thus enabling a high sensor sensitivity with respect to measurement tube vibrations.

In one embodiment, the magnet groups are each retained in the respective cavity by means of an adhesive, wherein the adhesive is especially a ceramic adhesive.

In one embodiment, the cavity wall in the region of the first opening has at least one undercut 15.53 on an inner side facing toward the respective cavity, which undercut is configured to receive a portion of the adhesive.

After the adhesive cures, the magnet group is thus securely fixed and is not delocalized, for example by measurement tube vibrations.

In one embodiment, a wall of the cavity on a side of the cavity facing toward the respective other arm has, at least in portions, a first wall thickness that is smaller than a wall thickness of the cavity wall of other cavity sides, or wherein a wall of the cavity has a second opening, at least in portions, on a side of the cavity facing toward the respective other cavity. In this way, a magnetic flux between the magnet groups can be increased.

In one embodiment, the first opening can be closed by means of a folding mechanism or a bracket mechanism, wherein a flap or the bracket is a component of the retainer.

As an alternative or in addition to the adhesive bonding of the magnet groups, a fixing of the magnet groups can thereby be realized.

In one embodiment, each magnet group has two magnets and at least one magnetically conductive closure device, wherein the magnetic fields of the two magnets are oriented opposite to one another, and wherein the closure device is configured to conduct and merge field lines of the magnetic fields of the two magnets, wherein the magnets are mechanically contacted with the closure device, wherein magnetic fields of opposing magnets of different magnet groups are rectified.

This produces a spatially highly localized, inhomogeneous magnetic field, whereby sensor sensitivity is further increased.

In one embodiment, the at least one coil has a central region and a winding region comprising the central region, wherein, in an idle state of the at least one measurement tube, a boundary between the magnets of a magnet group, as projected onto the cross-sectional plane, is located at least in portions in the central region.

Relative movements between the coil and the magnet arrangement thereby cause a strong induction of electrical voltages in the coil.

In the direction of the relative movements caused by measurement tube vibrations, the central region of the coil preferably has an extent that is greater than vibration amplitudes typical of the measurement tube, wherein especially the boundary between the magnets travels perpendicular to the direction of the relative movement, wherein, in the idle state, the boundary is advantageously arranged centrally with respect to an extent of the central region in the direction of the relative movement.

In one embodiment, the cavity wall at least in portions has a first geometric structure on a side facing away from the first opening, and wherein the magnet group has a second geometric structure which is complementary to the second structure at least in portions, wherein the magnet group, in the installed state, is configured to terminate, in a fitting manner, with the first geometric structure by means of the second geometric structure.

In one embodiment, the measuring sensor has two collectors, wherein a first collector on an upstream side of the measuring sensor is configured to receive a medium flowing from a pipeline into the measuring sensor and to guide it to the inlet of the at least one measurement tube, wherein a second collector is configured to receive the medium exiting the outlet of the at least one measurement tube and guide it into the pipeline.

In one embodiment, the measuring sensor has a measurement tube, wherein the retainer/coil arrangement of the sensor or exciter is respectively fastened to the measurement tube, and wherein the coil arrangement/retainer of the sensor or exciter is respectively fastened to the supporting element, or wherein the measuring sensor has a pair of measurement tubes, wherein the retainer/coil arrangement of the sensor or exciter is respectively fastened to a first measurement tube, and the coil arrangement/retainer is respectively fastened to a second measurement tube.

In one embodiment, the sensor has two measurement tube pairs.

In one embodiment, the retainer is made of at least one 3D-printable metal or at least one metal alloy, such as steel or aluminum.

A Coriolis measuring device according to the invention comprises: a Coriolis sensor according to one of the preceding claims; an electronic measuring/operating circuit, wherein the electronic measuring/operating circuit is configured to electrically charge the coils and optionally the associated temperature measuring instrument, wherein the charging of the coil and of the temperature measuring instrument is effected by means of separate electrical connections or by means of multiplexing, wherein the at least one electrical connection of a sensor or exciter is guided to the electronic measuring/operating circuit by means of a cable guide, wherein the electronic measuring/operating circuit is further configured to determine and provide mass flow rate readings and/or density readings, wherein the measuring instrument especially has an electronics housing for housing the electronic measuring/operating circuit.

The invention will now be described with reference to exemplary embodiments.

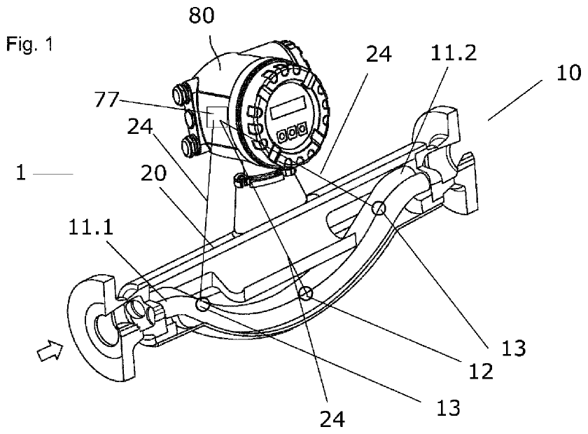

FIG. 1 shows a Coriolis measuring device 1 with an example of a Coriolis sensor according to the invention.

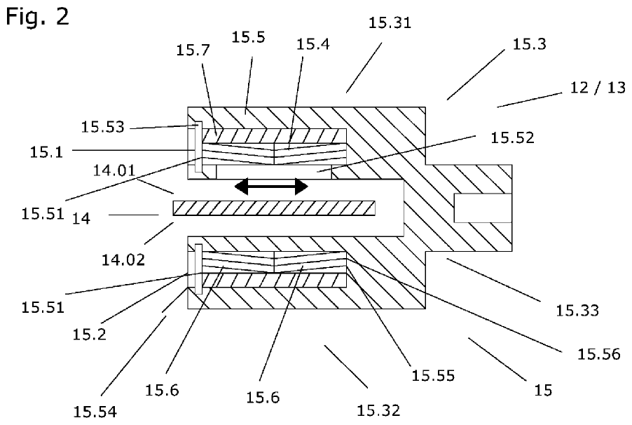

FIG. 2 shows a section through a sensor element or exciter.

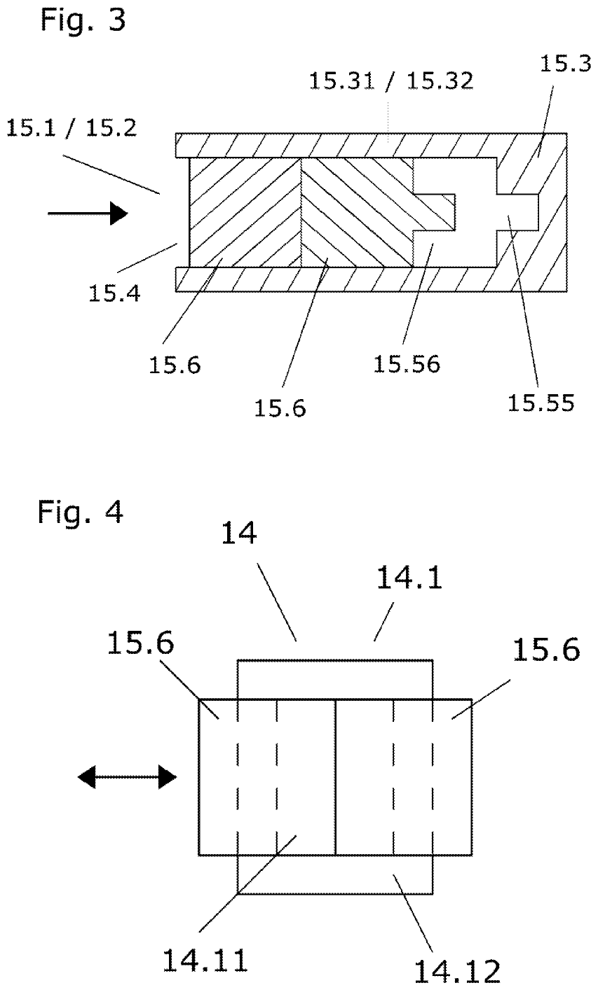

FIG. 3 shows a detail of a section through a retainer according to the invention for magnets with a magnet group.

FIG. 4 schematically illustrates an arrangement of a magnet group with respect to a coil in the idle state of a measurement tube.

FIG. 1 shows an example of a Coriolis measuring device 1 with an exemplary Coriolis sensor 10. The sensor comprises a supporting element 20, a first measurement tube 11.1, and a second measurement tube 11.2. The sensor furthermore comprises an exciter 12 for exciting measurement tube vibrations, and two sensor elements 13 for detecting measurement tube vibrations. The Coriolis measuring device comprises an electronics housing 80, in which is arranged an electronic measuring/operating circuit 77 which is configured to operate the exciter and the sensor elements and to provide measured values with respect to a medium flowing through the measurement tubes. The exciter and the sensor elements are connected to the electronic measuring/operating circuit 77 by means of electrical connections 24.

The embodiment shown here is by way of example; the sensor can thus also have only one measurement tube or more than two measurement tubes.

FIG. 2 shows a section through an exciter 12 or sensor element 13, with a retainer 15.3 according to the invention for magnets with magnet groups, as well as a coil arrangement 14.

The retainer 15.3 has a U-shape with a first arm 15.31, a second arm 15.32, and a base 15.33 connecting the arms. The retainer engages around the coil arrangement so that the first arm is arranged on a first side of the coil arrangement 14.01 with respect to a coil cross section, and the second arm is arranged on a second side of the coil arrangement 14.02, wherein a first magnet group 15.1 is retained on the first side of the coil arrangement by the retainer, and wherein a second magnet group 15.2 is retained on the second side of the coil arrangement by the retainer. As shown here, each magnet group may have two magnets 15.6, wherein the magnets of one magnet group advantageously have differently oriented magnetic fields. Opposing magnets of different magnet groups advantageously have magnetic fields of the same orientation. In this way, an overall magnetic field generated by the individual magnetic fields has strong inhomogeneity. Relative movements between coil arrangement 14 and retainer 15.3 lead to a strong induction of electric fields in a coil of the coil arrangement 14.01 insofar as the inhomogeneity decreases in a central region of the coil 14.1; see also FIG. 4 in this respect. In order to strengthen the magnetic flux of the magnetic fields, the magnet group has, in addition to two magnets, a magnetically conductive closure device which is configured to close field lines of magnetic fields of adjacent magnets of a magnet group. The closure device is thereby made of a ferromagnetic material, for example.

The retainer is preferably formed from a magnetically non-conductive or only weakly conductive material, such as stainless steel or aluminum.

The retainer has a cavity 15.4 in the region of each of the arms, wherein the cavities are configured to receive the magnet groups. The cavities are respectively formed by a cavity wall 15.5, wherein the cavity wall respectively has at least one first opening 15.51 for receiving a magnet group. As shown in the first arm 15.31, each arm can have a second opening 15.52 on a side of the associated cavity facing toward the coil arrangement, in order to reduce a magnetic resistance of the retainer. Alternatively, a wall thickness can be reduced for the same purpose as shown in the second arm 15.32.

The magnet groups 15.1, 15.2 are advantageously each retained in the respective cavity by means of an adhesive, wherein the adhesive is especially a ceramic adhesive. As shown here, an undercut in the cavity wall in the region of the corresponding first opening can be configured to receive a portion of an adhesive compound upon inserting the magnet groups into the respective cavity. After the adhesive compound cures, the adhesive compound is anchored in the undercut and secures the magnet group so that it is immovably located in the cavity.

Furthermore, the first opening 15.51 can, for example, be closable by means of a closure mechanism 15.54 as shown here. The closure mechanism can be a folding mechanism or a bracket mechanism, for example.

The retainer is produced especially by means of a 3D printing process. It can thereby be manufactured in a compact and lightweight form so that, when fastened to a measurement tube, measurement tube vibrations are influenced only slightly and in a non-disruptive manner.

The retainer can, for example, have a bore for fastening to a fastening device. A person skilled in the art will select a manner of fastening in accordance with their requirements.

Typical dimensions of a convex envelope of the retainer are 15 mm * 10 mm * 5 mm, wherein each dimensional specification can deviate by less than 40% from said value.

Typical dimensions of a magnet are 5 mm * 3.5 mm * 2 mm, wherein each dimensional specification can deviate by less than 40% from said value. The magnets may also have a round or oval cross section.

Typical dimensions of the magnetically conductive closure device are 5 mm * 3.5 mm * 1 mm, wherein each dimensional specification can deviate by less than 30% from said value.

FIG. 3 illustrates a section through a cavity with a magnet group located therein. As shown here, the cavity wall can at least in portions have a first geometric structure 15.55 on a side facing away from the first opening, wherein an associated magnetic group can have a second geometric structure 15.56 which is complementary to the first geometric structure at least in portions, wherein the magnet group in the installed state is configured to terminate, in a fitting manner, with the first geometric structure by means of the second geometric structure. As shown here, the geometric structures may have a rectangular shape. Any other shape, such as a triangular shape, can be used just as well. Among other things, a triangular shape is advantageous since no precisely targeted insertion of the magnet group is necessary during assembly; rather, the end position occurs automatically.

FIG. 4 illustrates a relative positioning of a magnet group with two magnets 15.6 with respect to a coil arrangement 14 with a coil 14.1. The coil has a central region 14.11 and a winding region surrounding the central region. In an idle state of the at least one measurement tube, a boundary between the magnets of a magnet group, projected onto the cross-sectional plane, is preferably located at least approximately in a center of the central region.

In the direction of the relative movements caused by measurement tube vibrations, the central region of the coil preferably has an extent that is larger than vibration amplitudes typical of the measurement tube and that is smaller than two times a typical vibration amplitude.

The boundary between the magnets thereby preferably travels perpendicular to the direction of the relative movement. Relative movements between the coil and the magnet arrangement thereby cause a strong induction of electrical voltages in the coil.

Given a single-tube Coriolis sensor, the retainer 15.3 of a sensor element or exciter is preferably arranged on the measurement tube, and the coil arrangement of a sensor element or exciter is preferably arranged on the supporting element 20 by means of a retaining device.

Given a double-tube Coriolis sensor, the retainer of a sensor element or exciter is preferably fastened to a first measurement tube, and the coil arrangement of a sensor element or exciter is preferably fastened to a second measurement tube.

### LIST OF REFERENCE SIGNS

1 Coriolis measuring device

10 Coriolis sensor

11 Measurement tube

11.1 First measurement tube

11.2 Second measurement tube

12 Exciter

13 Sensor element

14 Coil arrangement

14.01 First side of the coil arrangement

14.02 Second side of the coil arrangement

14.1 Coil

14.11 Central region

14.12 Winding region

15 Magnet arrangement

15.1 First magnet group

15.2 Second magnet group

15.3 Retainer for magnets

15.31 First arm

15.32 Second arm

15.33 Connecting base

15.4 Cavity

15.5 Cavity wall

15.51 First opening

15.52 Second opening

15.53 Undercut

15.54 Closing mechanism

15.55 First geometric structure

15.56 Second geometric structure

15.6 Magnet

15.7 Magnetically conductive closure device

20 Supporting element

77 Electronic measuring/operating circuit

80 Electronics housing

1-13. (canceled)

14. A Coriolis measuring sensor of a Coriolis measuring instrument for detecting a mass flow rate or a density of a medium flowing through the Coriolis measuring instrument, the sensor comprising:
at least one measurement tube having an inlet and an outlet and configured to convey the medium between the inlet and outlet;
a supporting element configured to retain the at least one measurement tube;
at least one exciter configured to excite the at least one measurement tube to vibrate; and
at least two sensor elements, each configured to detect vibrations of the at least one measurement tube,
wherein the at least one exciter and/or at least one sensor element of the at least two sensor elements each respectively have a coil arrangement with at least one coil, respectively, and each have a magnet arrangement, wherein each magnet arrangement and each corresponding coil arrangement are movable relative to each other,
wherein each magnet arrangement includes a retainer for magnets, at least one first magnet group including at least one magnet, and at least one second magnet group including at least one magnet, wherein the retainer is U-shaped, including a first arm, a second arm and a base connecting the arms, wherein the retainer engages around the corresponding coil arrangement such that the first arm is arranged on a first side of the corresponding coil arrangement with respect to a coil cross-section, and wherein the second arm is arranged on a second side of the corresponding coil arrangement,
wherein the first magnet group is retained on the first side of the corresponding coil arrangement by the retainer, and wherein the second magnet group is retained on the second side of the corresponding coil arrangement by the retainer,
wherein the retainer includes a cavity in a region of each of the first and second arms, wherein each cavity is configured to receive one of the magnet groups, wherein the cavities are each defined by a corresponding cavity wall, wherein the corresponding cavity wall includes at least one first opening adapted to receive the magnet group, and
wherein the retainer is manufactured using a three-dimensional (3D) printing process.

15. The sensor of claim 14, wherein the at least one first and second magnet groups are each retained in the respective cavity using an adhesive.

16. The sensor of claim 15, wherein the adhesive is especially a ceramic adhesive.

17. The sensor of claim 15, wherein each respective cavity wall includes at least one undercut in a region of the at least one first opening on an inner side adjacent the respective cavity, which at least one undercut is configured to receive a portion of the adhesive.

18. The sensor of claim 14, wherein a wall of the cavity on a side of the cavity facing toward a respective opposing arm has, at least in portions, a first wall thickness that is smaller than a wall thickness of the cavity wall of other cavity sides, or
wherein a wall of the cavity has a second opening, at least in portions, on a side of the cavity facing toward the respective opposing cavity.

19. The sensor of claim 14, wherein the at least one first opening can be closed by a closure mechanism, including a folding mechanism or a bracket mechanism, wherein a flap or a bracket is a component of the retainer.

20. The sensor of claim 14, wherein each magnet group includes two magnets and at least one magnetically conductive closure device, wherein magnetic fields of the two magnets are oriented opposite each other, and wherein the closure device is configured to conduct and merge field lines of the magnetic fields of the two magnets,
wherein the magnets are mechanically contacted with the closure device, and wherein magnetic fields of opposing magnets of different magnet groups are rectified.

21. The sensor of claim 14, wherein the at least one coil has a central region, and a winding region comprising the central region, wherein, in an idle state of the at least one measurement tube, a boundary between magnets of each magnet group, as projected onto the cross-sectional plane, is disposed at least in portions in the central region.

22. The sensor of claim 14, wherein the cavity wall, at least in portions, includes a first structure on a side opposite the first opening, and wherein an associated magnet group of the at least one first and second magnet groups includes a second structure which is complementary to the first structure at least in portions,
wherein the associated magnet group, in the installed state, is configured to terminate, in a fitting manner, with the first structure via the second geometric structure.

23. The sensor of claim 14, further comprising two collectors, including:
a first collector on an upstream side of the sensor configured to receive the medium flowing from a source flow into the sensor and to guide the medium to the inlet of the at least one measurement tube; and
a second collector configured to receive the medium exiting the outlet of the at least one measurement tube and to guide the medium into the source flow.

24. The sensor of claim 14, wherein the at least one measurement tube of the sensor includes a single measurement tube, wherein the retainer and corresponding coil arrangement of the at least one exciter or the at least one sensor element are respectively fastened to the measurement tube, and wherein the coil arrangement and the retainer of the at least one exciter or the at least one sensor element are respectively fastened to the supporting element, or
wherein the at least one measurement tube of the sensor includes a measurement tube pair, wherein the retainer and corresponding coil arrangement of the at least one exciter or the at least one sensor element are respectively fastened to a first measurement tube of the measurement tube pair, and wherein the coil arrangement and the retainer of the at least one exciter or the at least one sensor element are respectively fastened to a second measurement tube of the measurement tube pair.

25. The sensor of claim 24, wherein the at least one measurement tube of the sensor includes two measurement tube pairs.

26. The sensor of claim 14, wherein the retainer of each magnet arrangement is made of at least one 3D-printable metal or at least one metal alloy.

27. A Coriolis measuring device, comprising:
a Coriolis sensor according to claim 14;
an electronic circuit configured to operate the at least two sensor element and the at least one exciter, wherein the at least two sensor element and the at least one exciter are connected to the electronic circuit via electrical connections; and
an electronics housing adapted to contain the electronic circuit,
wherein the electronic circuit is further configured to determine and output mass flow rate values and/or density values of the medium.
